(19) United States
(12) Patent Application Publication
(10) Pub. No.: US 2008/0101274 A1
(43) Pub. Date: May 1, 2008

(54) METHOD AND SYSTEM FOR DELAYING A PUSH TO CONNECT CHANNEL ESTABLISHMENT

(75) Inventors: EDWARD L. GILMORE, SUNRISE, FL (US); JARED R. DANIELS, SUNRISE, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/555,020

(22) Filed: Oct. 31, 2006

(51) Int. Cl. H04J 3/08

(52) U.S. Cl. 370/315

(57) ABSTRACT

A method (10) and system (30 or 200) for delaying a push to connect channel establishment (38) in a mobile device (22) includes a first transceiver (32) having an optional streaming data channel (34) established, a second transceiver (33) for establishing the push to connect channel establishment, and a processor (39) operatively coupled to the first and second transceivers. The processor can be programmed to delay (14) the push to connect channel establishment upon initiation of a push-to-connect request signal (35), halt (16) the streaming data channel (36), and establish (19) the push to connect channel. The processor can further add (18) a synchronous connection (SCO) (37) before establishing the push to connect channel and after halting the streaming data channel. The streaming data channel can be an asynchronous stereo connection using A2DP and the synchronous connection can be a synchronous connection using a hands-free audio profile (HFP).

### FIELD

This invention relates generally to communication systems, and more particularly to a method and system for improved push to connect channel establishment.

### BACKGROUND

For Bluetooth audio devices that support both Advanced Audio Distribution Profile (A2DP) and Handsfree Profile (HFP), there is a latency associated with switching from A2DP to HFP when an outgoing call from a mobile handset is initiated from the handset. A2DP is a stereo profile used for listening to music or MP3 files and HFP is a handsfree profile used for call audio on cellular phones and similar radio communication devices. The latency problem is especially critical and evident in the case of a handset or mobile originated push-to-talk (PTT) communication establishment. In other words, the problem is evident when a user is listening to music using Bluetooth stereo and the user decides to initiate a PTT call. In such instances, call audio (voice communications in this scenario) can be lost if the Bluetooth audio link is not properly configured prior to the PTT channel establishment. Note, in addition to the latency involved with transitioning from A2DP to HFP, there is another latency that exists in just establishing a synchronous connection such as an connection using HFP.

Note, A2DP defines how high quality audio (stereo or mono) can be streamed from one device to another over a Bluetooth connection. An example is music streamed from a mobile phone to a wireless headset. Many new mobile phones and portable media players support A2DP. Further note that several newer Bluetooth devices include Windows XP, Linux, or Apple MAC OS drivers that support A2DP.

### SUMMARY

Embodiments in accordance with the present invention can provide a viable audio path before a push to connect channel or other voice communication channel is established that overcomes the detriments described above.

In a first embodiment of the present invention, a method for delaying a push to connect channel establishment in a communication device can include the steps of optionally establishing a streaming data channel, delaying the push to connect channel establishment upon initiation of a push-to-connect request signal until a synchronous connection is established, halting the streaming data channel (if one exists), and establishing the push to connect channel (with a wireless communication network for example). The method can establish the synchronous connection before establishing the push to connect channel and after halting the optional streaming data channel. The method can establish the streaming data channel by establishing a high quality audio or video streaming channel or by establishing a Bluetooth connection using an Advanced Audio Distribution Profile (A2DP). The streaming data channel can be an asynchronous stereo connection using A2DP and the synchronous connection can be a synchronous connection using a hands-free audio profile for example. The push to connect channel establishment can be a push-to-talk connection, a push-to-view connection, a push-to-connect over cellular connection, a push-to-locate connection, or a talk-around connection or any other “Push-to-x” type connection. The push to connect channel establishment can also be a voice call channel establishment.

In a second embodiment of the present invention, a system for delaying a push to connect channel establishment in a communication device can include a first transceiver, a second transceiver for establishing the push to connect channel establishment, and a processor operatively coupled to the first transceiver and the second transceiver. The processor can be programmed to initiate an establishment of a synchronous connection, delay the push to connect channel establishment upon initiation of a push-to-connect request signal until the synchronous connection is established, and establish the push to connect channel. The processor can be further programmed to establish a streaming data channel before initiation of the push-to-connect request and to halt the streaming data channel before establishing the push to connect channel. The push to connect channel establishment can be with a wireless (or a wired) communication network and the push to connect channel establishment can be a push-to-talk connection, a push-to-view connection, a push-to-locate connection, a push-to-connect over cellular (PoC) connection, or a talk-around (MotoTalk) connection. The processor can establish the streaming data channel by establishing a high quality audio streaming channel or by establishing a Bluetooth connection using an Advanced Audio Distribution Profile (A2DP). The streaming data channel can be an asynchronous stereo connection using A2DP and the synchronous connection can be a synchronous connection using a hands-free audio profile (HFP). Note, the push to connect channel establishment can be a voice call channel establishment.

In a third embodiment of the present invention, a portable wireless communication unit having a system of delaying a push to connect channel establishment can include a short range wireless transceiver having a streaming audio channel established, a long range wireless transceiver for establishing the push to connect channel establishment, and a processor operatively coupled to the short range transceiver and the long range transceiver. The processor can be programmed to delay the push to connect channel establishment upon initiation of a push-to-connect request signal, halt the streaming data channel, and establish the push to connect channel. The processor can be further programmed to add a synchronous connection after halting the streaming data channel, but before establishing the push to connect channel.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements.

Other embodiments, when configured in accordance with the inventive arrangements disclosed herein, can include a system for performing and a machine readable storage for causing a machine to perform the various processes and methods disclosed herein.

### BRIEF DESCRIPTION OF THE DRAWINGS

FIG. 1 is a flow chart of a method for delaying a push to connect channel establishment in a communication device in accordance with an embodiment of the present invention.

FIG. 2 is a timing diagram illustrating an existing system and method of establishing a push to talk connection.

FIG. 3 is a timing diagram illustrating a method and system of establishing a push to connect channel establishment in accordance with an embodiment of the present invention.

FIG. 4 is a block diagram of a system of establishing a push to connect channel establishment in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways that can enable a cell phone user or even a landline user to have a guarantee of a viable audio channel for voice communications when using a streaming data or audio link immediately before requesting the audio channel.

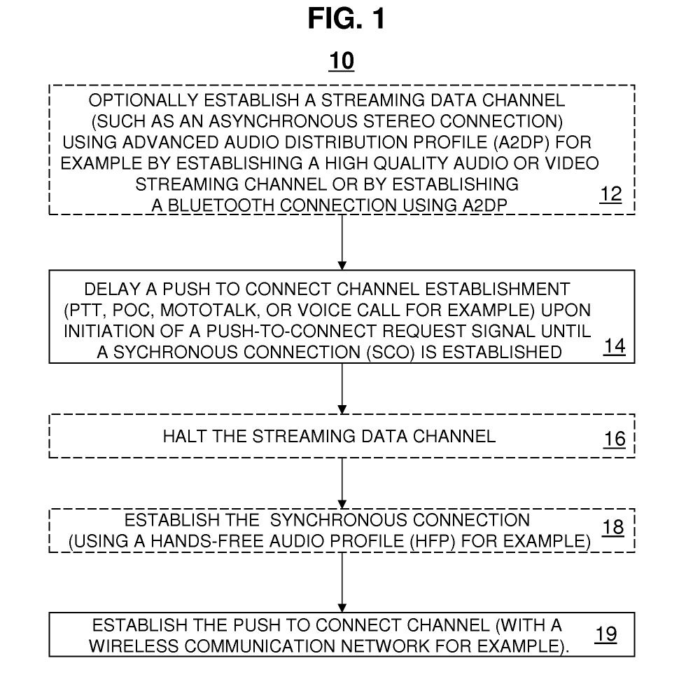

Referring to FIG. 1, a flow chart illustrating a method 10 for delaying a push to connect channel establishment in a communication device can include the step 12 of optionally establishing a streaming data channel, delaying the push to connect channel establishment upon initiation of a push-to-connect request signal until a synchronous connection is established at step 14, optionally halting the streaming data channel at step 16 (if a streaming data channel exists), and establishing the push to connect channel (with a wireless communication network for example) at step 19. The method 10 can further establish the synchronous connection at step 18 before establishing the push to connect channel and after halting the streaming data channel. The method 10 can establish the streaming data channel by establishing a high quality audio or video streaming channel or by establishing a Bluetooth connection using an Advanced Audio Distribution Profile (A2DP). The streaming data channel can be an asynchronous stereo connection using A2DP and the synchronous connection can be a synchronous connection using a hands-free audio profile. The streaming data channel can also be dial-up networking, object push profile transfer or any other channel that has an associated latency. The push to connect channel establishment can be any “push-to-x” type connection such as a push-to-talk connection, a push-to-view connection, a push-to-locate connection, a push-to-connect over cellular (PoC) connection, or a talk-around connection such as MotoTalk by Motorola, Inc. of Schaumburg, Ill. The push to connect channel establishment can also be a voice call channel establishment. For example, if a user of a Bluetooth headset that is coupled to a landline and the Bluetooth headset also is able to listen to streaming MP3 songs or other audio, the embodiments in accordance with the present invention will halt the streaming audio before creating a voice call connection for the user. Such a system will also likely add a synchronous connection (SCO) for audio voice communications before establishing the voice call connection.

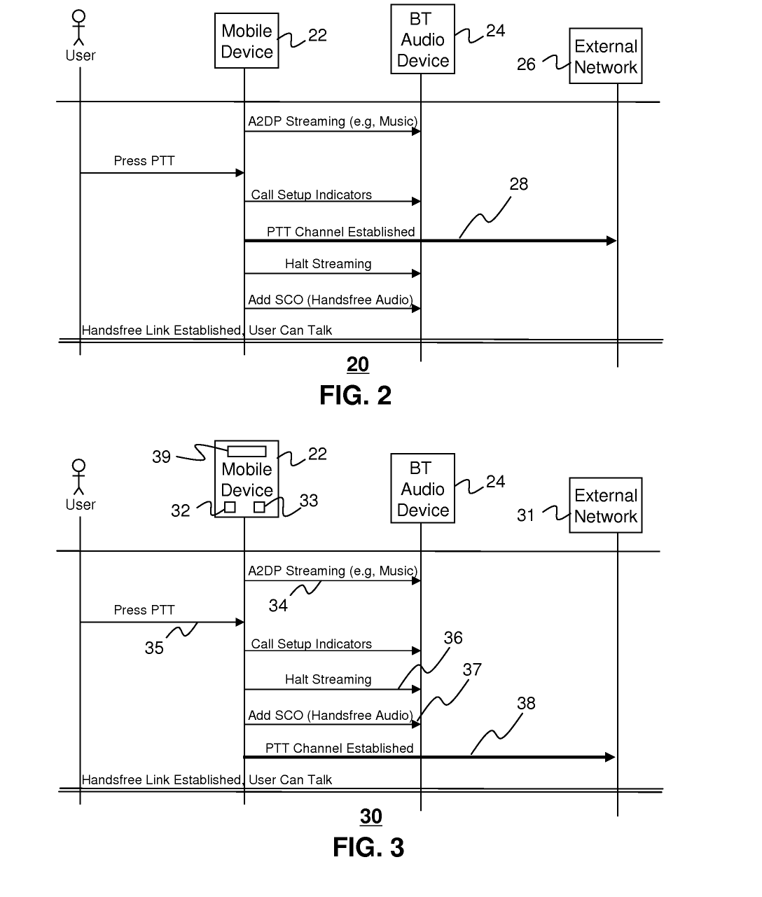

An existing system 20 as illustrated in FIG. 2 can include a mobile device 22, a Bluetooth device such as a Bluetooth headset and an external wireless network 26. A user can be listening to streaming music and then request a push-to-talk (PTT) connection. Under such current system, the PTT channel is established at step 28, but the Bluetooth audio channel will necessarily not be established before the streaming audio is halted and other steps are done that can enable viable voice communications. This arrangement can cause the user's voice audio to be lost when attempting to establish the handsfree link. Even when there is no streaming audio, the latency caused by just establishing the handsfree link or any other synchronous connection can cause the loss of voice audio when a push-to-connect channel is established.

Instead, a system 30 in accordance with an embodiment of the present invention can include a system for delaying a push to connect channel establishment 38 in a communication device such as the mobile device 22. The system can include a first transceiver 32 having a streaming data channel 34 that can be optionally established, a second transceiver 33 for establishing the push to connect channel establishment 38, and a processor 39 operatively coupled to the first transceiver and the second transceiver. The processor 39 can be programmed to delay the push to connect channel establishment 38 upon initiation of a push-to-connect request signal 35 until a synchronous channel or connection is established. The processor 39 can also optionally halt the streaming data channel at step 36, and establish the push to connect channel at step 38 after establishment of an optional synchronous connection (SCO) 37. The processor 39 can be programmed to add the synchronous connection (SCO) 37 before establishing the push to connect channel 38 and after halting the streaming data channel at step 36. The push to connect channel establishment 38 can be with a wireless (or a wired) communication network 31 and the push to connect channel establishment can be a push-to-talk connection, a push-to-view connection, a push-to-locate connection, a push-to-connect over cellular (PoC) connection, or a talk-around (MotoTalk) connection. The processor 39 can establish the streaming data channel by establishing a high quality audio or video streaming channel for example or by establishing a Bluetooth connection using an Advanced Audio Distribution Profile (A2DP). The streaming data channel can be an asynchronous stereo connection using A2DP and the synchronous connection can be a synchronous connection using a hands-free audio profile (HFP) for example. Note, the push to connect channel establishment can be a voice call channel establishment as noted above.

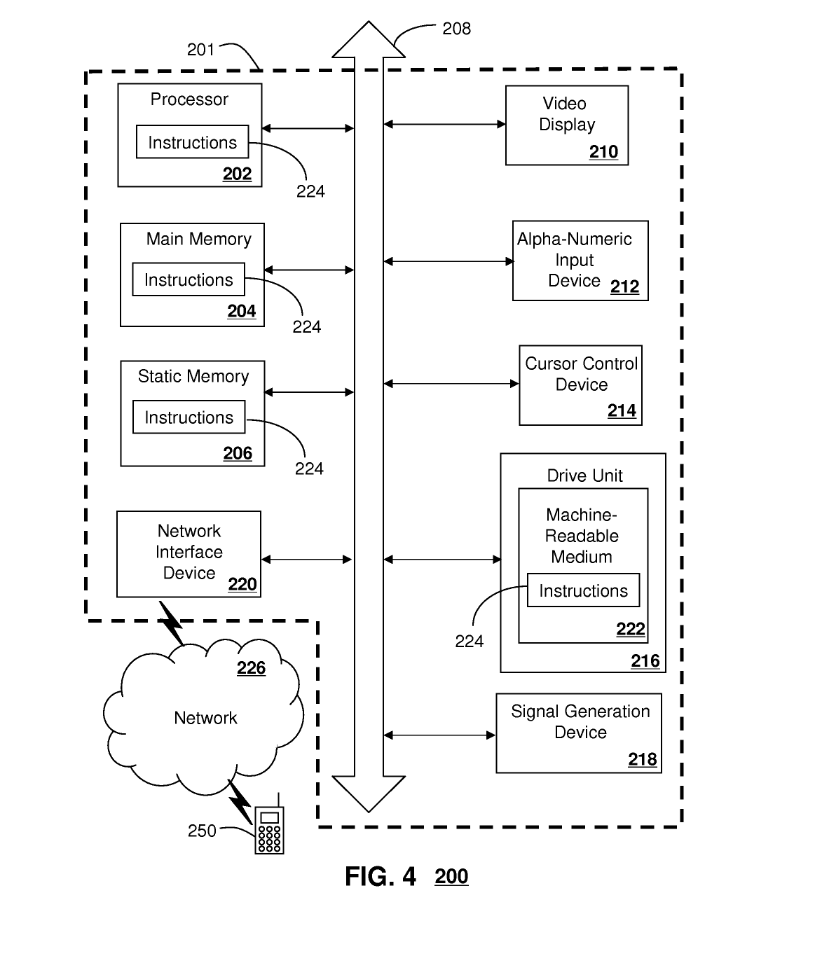

FIG. 4 depicts an exemplary diagrammatic representation of a machine in the form of a computer system 200 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. For example, the computer system can include a recipient device 201 and a sending device 250 or vice-versa.

The machine may comprise a server computer, a client user computer, a personal computer (PC), a tablet PC, personal digital assistant, a cellular phone, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 200 can include a controller or processor 202 (e.g., a central processing unit (CPU), a graphics processing unit (GPU, or both), a main memory 204 and a static memory 206, which communicate with each other via a bus 208. The computer system 200 may further include a presentation device such as a video display unit 210 (e.g., a liquid crystal display (LCD), a flat panel, a solid state display, or a cathode ray tube (CRT)). The computer system 200 may include an input device 212 (e.g., a keyboard), a cursor control device 214 (e.g., a mouse), a disk drive unit 216, a signal generation device 218 (e.g., a speaker or remote control that can also serve as a presentation device) and a network interface device 220. Of course, in the embodiments disclosed, many of these items are optional.

The disk drive unit 216 may include a machine-readable medium 222 on which is stored one or more sets of instructions (e.g., software 224) embodying any one or more of the methodologies or functions described herein, including those methods illustrated above. The instructions 224 may also reside, completely or at least partially, within the main memory 204, the static memory 206, and/or within the processor 202 during execution thereof by the computer system 200. The main memory 204 and the processor 202 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but are not limited to, distributed processing or component/object distributed processing, parallel processing, or virtual machine processing can also be constructed to implement the methods described herein. Further note, implementations can also include neural network implementations, and ad hoc or mesh network implementations between communication devices.

The present disclosure contemplates a machine readable medium containing instructions 224, or that which receives and executes instructions 224 from a propagated signal so that a device connected to a network environment 226 can send or receive voice, video or data, and to communicate over the network 226 using the instructions 224. The instructions 224 may further be transmitted or received over a network 226 via the network interface device 220.

While the machine-readable medium 222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a midlet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method for delaying a push to connect channel establishment in a communication device, comprising the steps of:
initiating an establishment of a synchronous connection;
delaying the push to connect channel establishment upon initiation of a push-to-connect request signal until the synchronous connection is established; and
establishing the push to connect channel after the establishment of the synchronous connection.

2. The method of claim 1, wherein the method further comprises the steps of establishing a streaming data channel before initiation of the push-to-connect request signal and halting the streaming data channel before establishing the push to connect channel.

3. The method of claim 1, wherein the push to connect channel establishment is with a wireless communication network.

4. The method of claim 2, wherein the step of establishing the streaming data channel comprises establishing a high quality audio or video streaming channel.

5. The method of claim 2, wherein the step of establishing a streaming data channel comprises establishing a Bluetooth connection using an Advanced Audio Distribution Profile (A2DP).

6. The method of claim 2, wherein the streaming data channel is an asynchronous stereo connection using A2DP and the synchronous connection is a synchronous connection using a hands-free audio profile.

7. The method of claim 1, wherein the push to connect channel establishment is a push-to-talk connection, a push-to-view connection, a push-to-locate connection, a push-to-connect over cellular connection, or a talk-around connection.

8. The method of claim 1, wherein the push to connect channel establishment is a voice call channel establishment.

9. A system for delaying a push to connect channel establishment in a communication device, comprising:
a first transceiver;
a second transceiver for establishing the push to connect channel establishment; and
a processor operatively coupled to the first transceiver and the second transceiver, wherein the processor is programmed to:
initiate an establishment of a synchronous connection;
delay the push to connect channel establishment upon initiation of a push-to-connect request signal until the synchronous connection is established; and
establish the push to connect channel after the establishment of the synchronous connection.

10. The system of claim 9, wherein the processor is further programmed to establish a streaming data channel before initiation of the push-to-connect request signal and to halt the streaming data channel before establishing the push to connect channel.

11. The system of claim 9, wherein the push to connect channel establishment is with a wireless communication network and the push to connect channel establishment is a push-to-talk connection, a push-to-view connection, a push-to-locate connection, a push-to-connect over cellular connection, or a talk-around connection.

12. The system of claim 10, wherein the processor establishes the streaming data channel by establishing a high quality audio or video streaming channel.

13. The system of claim 10, wherein the processor establishes the streaming data channel by establishing a Bluetooth connection using an Advanced Audio Distribution Profile (A2DP).

14. The system of claim 10, wherein the streaming data channel is an asynchronous stereo connection using A2DP and the synchronous connection is a synchronous connection using a hands-free audio profile (H FP).

15. The system of claim 9, wherein the push to connect channel establishment is a voice call channel establishment.

16. A portable wireless communication unit having a system of delaying a push to connect channel establishment, comprising:
a short range wireless transceiver having a streaming audio channel established;
a long range wireless transceiver for establishing the push to connect channel establishment a processor operatively coupled to the short range transceiver and the long range transceiver, wherein the processor is programmed to:
delay the push to connect channel establishment upon initiation of a push-to-connect request signal;
halt the streaming data channel; and
establish the push to connect channel.

17. The portable wireless communication unit of claim 16, wherein the processor is further programmed to add a synchronous connection before establishing the push to connect channel and after halting the streaming data channel.

18. The portable wireless communication unit of claim 16, wherein the push to connect channel establishment is with a wireless communication network and the push to connect channel establishment is a push-to-talk connection, a push-to-view connection, a push-to-locate connection, a push-to-connect over cellular connection, or a talk-around connection.

19. The portable wireless communication unit of claim 16, wherein the streaming data channel is an asynchronous stereo connection using A2DP and the synchronous connection is a synchronous connection using a hands-free audio profile (HFP).

20. The portable wireless communication unit of claim 16, wherein the push to connect channel establishment is a voice call channel establishment.
